(19) United States
(12) Patent Application Publication
(10) Pub. No.: US 2002/0086679 A1
(43) Pub. Date: Jul. 4, 2002

(54) Method and apparatus for increasing cell use in a dedicated network

(76) Inventors: Bo Li, Plano, TX (US); Charles M. Feltner, Plano, TX (US)

Correspondence Address: Sanford E. Warren, Jr., Gardere Wynne Sewell LLP, 3000 Thanksgiving Tower, 1601 Elm Street, Suite 3000, Dallas, TX, 75201-4767, US

(21) Appl. No.: 09/751,094

(22) Filed: Dec. 29, 2000

(51) Int. Cl. H04Q 7/20

(52) U.S. Cl. 455/453; 455/450; 455/452

(57) ABSTRACT

The present invention may include a method of increasing cell use in a dedicated network. The method may include the steps of measuring cell traffic loads within the dedicated network, restricting access to the dedicated network during a first time period to users within the dedicated network, and allowing access to the dedicated network during a second time period to users outside the dedicated network.

### TECHNICAL FIELD OF THE INVENTION

The present invention relates generally to the field of telecommunications and more particularly to a method and apparatus for increasing cell use in a dedicated network.

### BACKGROUND OF THE INVENTION

In a telecommunications network, a network operator can define a network which is dedicated to a group of users. These networks are commonly known as localized service areas. The localized service area can include one or more cells. Within the localized service area, it is possible for the network operator to set certain characteristics or attributes of the localized service area. Some localized service area attributes may be managed as part of cell management, for example, exclusive access.

A cell can be an exclusive access cell. These exclusive access cells can belong to one or more localized service areas. The exclusive access cells will allow access only to users having the exclusive access cell included in their localized service area. Many times entire localized service areas having multiple cells will be exclusive access. These exclusive access cells and localized service areas prevent the mobile stations of the users outside the localized service area or without exclusive access from obtaining cellular service, except for emergency services.

The problem with this system is that the cells within an exclusive access localized service area lie dormant for a significant portion of the day. During these dormant periods, users outside the localized service area cannot acquire service from the cells within the localized service area because of the exclusive nature of the localized service area.

### SUMMARY OF THE INVENTION

The present invention may include a method of increasing cell use in a dedicated network. The method may include the steps of measuring cell traffic loads within the dedicated network, restricting access to the dedicated network during a first time period to users within the dedicated network, and allowing access to the dedicated network during a second time period to users outside the dedicated network.

The present invention may also include a computer program embodied on a computer readable medium for increasing cell use in a dedicated network. The computer program may include a code segment for measuring cell traffic loads within the dedicated network. The computer program may also include a code segment for restricting access to the dedicated network during a first time period to users within the dedicated network. The computer program may further include a code segment for allowing access to the dedicated network during a second time period to users outside the dedicated network.

The present invention may further include a method of increasing cell use in a dedicated network. The method may include the steps of determining a threshold level of cell traffic load for the one or more cells within the dedicated network, assessing the one or more cells to determine if any cells have cell traffic loads below the threshold level, and allowing access by users outside the dedicated network to the cells with traffic loads below the threshold level.

Additionally, the present invention may include a computer program embodied on a computer-readable medium for increasing cell use in a dedicated network. The computer program may include a code segment for determining a threshold level of cell traffic load for the one or more cells within the dedicated network. The computer program may also include a code segment for assessing the one or more cells to determine if any cells have cell traffic loads below the threshold level. The computer program may further include a code segment for allowing access by users outside the dedicated network to the cells with cell traffic loads below the threshold level.

The present invention may also include a method of increasing cell use within a dedicated network having the steps of measuring cell traffic loads for one or more cells within the dedicated network, determining for each of the one or more cells time periods in which the cell load traffic due to users within the dedicated network is substantially minimal, and allowing access to the one or more cells during the time periods when the cell load traffic due to users within the dedicated network is substantially minimal.

The present invention may further include a computer program embodied on a computer-readable medium for increasing cell use in a dedicated network. The computer program may include a code segment for measuring cell traffic loads for one or more cells within the dedicated network. The computer program may also include a code segment for determining for each of the one or more cells time periods in which the cell load traffic due to users within the dedicated network is substantially minimal. In addition, the computer program may include a code segment for allowing access to the one or more cells during the time periods when the cell load traffic due to users within the dedicated network is substantially minimal.

Other features and advantages of the present invention shall be apparent to those of ordinary skill in the art upon reference to the following detailed description taken in conjunction with the accompanying drawings.

### BRIEF DESCRIPTION OF THE DRAWINGS

The above and further advantages of the invention may be better understood by referring to the following description in conjunction with the accompanying drawings in which corresponding numerals in the different figures refer to corresponding parts in which:

FIG. 1a is a diagram of a hierarchy cell structure with localized service areas;

FIG. 1b is a graphical representation of the cell traffic loads of the dedicated network of FIG. 1;

FIG. 2a is a diagram of a hierarchy cell structure with a localized service areas;

FIG. 2b is a flow diagram of a method of the present invention;

FIG. 2c-2f are graphical representations of the cell traffic loads of the localized service area of FIG. 2a;

FIG. 3 is a flow diagram of a method of the present invention;

FIG. 4a is a diagram of a hierarchy cell structure with localized service areas;

FIG. 4b is graphical representations of the cell traffic loads of the localized service area of FIG. 4a; and

FIG. 5 is a network diagram of a telecommunications network implementing the present invention.

### DETAILED DESCRIPTION

While the making and using of various embodiments of the present invention are discussed herein in terms of cellular telecommunications, it should be appreciated that the present invention provides many applicable inventive concepts, which can be embodied in a wide variety of specific contexts. The specific embodiments discussed herein are merely illustrative of specific ways to make and use the invention and does not limit the scope of the invention.

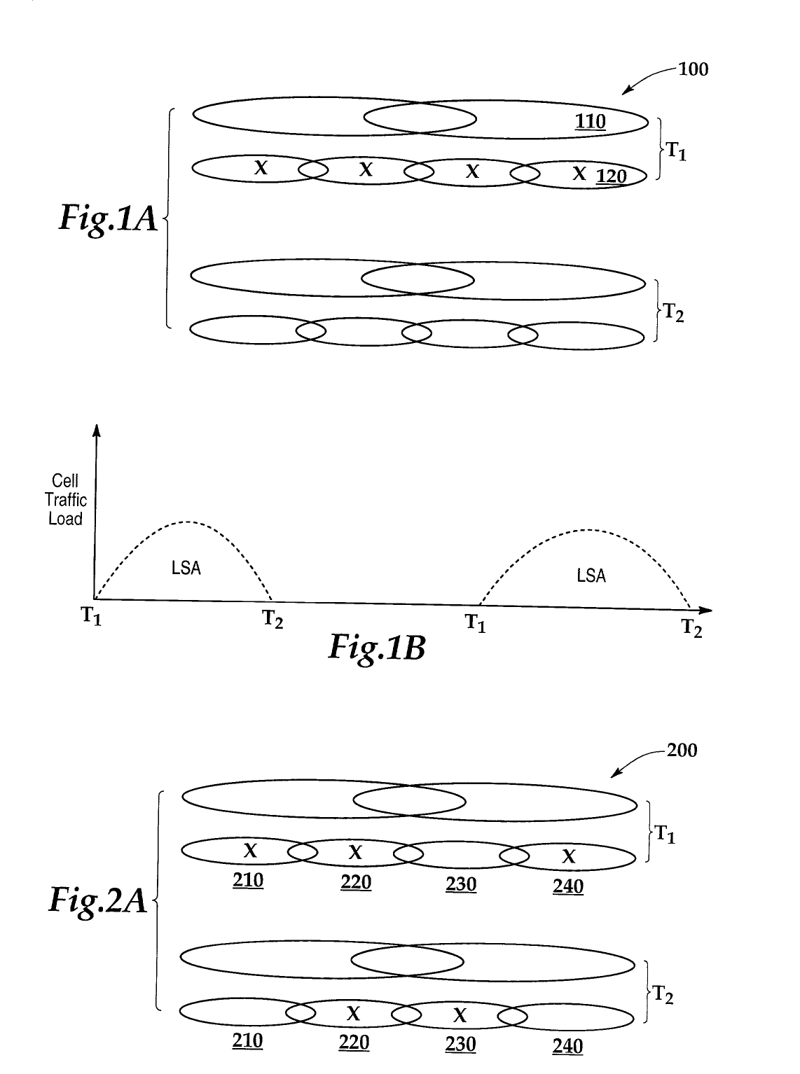

Referring to FIG. 1a, a telecommunications network represented by a hierarchial cell structure is generally depicted as 100. The dedicated telecommunications network is depicted in hierarchial form with the large subscriber areas being 110 and the small subscriber area being 120. The larger subscriber areas 110 function to serve customers in a large geographic area. Such large subscriber areas can comprise many small subscriber areas 120. Each small subscriber area can include one or more cells. In FIG. 1a, the small subscriber areas 120 are four individual cells. Each of these small subscriber areas can be a localized service area, dedicated to supporting only a specified group of users.

FIG. 1b shows an illustrative example of the present invention in the small subscriber area 120 of FIG. la. In FIG. 1b, a graph is shown illustrating the method of the present invention. Referring back to FIG. 1a, each cell in the small subscriber area is a localized area, as indicated by the “X” in the cell. During operation of the precent invention, the cell traffic loads for each of the cells in the small subscriber area are measured. The measurements are taken from a first time T₁, to a second time T₂, and from time T₂ back to time T₁, as shown in FIG. 1b. In the illustrative example provided by FIG. 1b, the time period between T₁ and T₂ has the highest cell traffic loads from users within the localized service area. During this time period, only the users within the localized service area can access the cells dedicated to that small subscriber area 120. This is shown in FIG. la by the “X” placed within the cells. Similarly, during the time period from T₂ to T₁, the cell traffic loads are minimal for users within the localized service areas of the small subscriber area 120. During this time period, access to the cells within the small subscriber area 120 can be available to all users. This is shown in FIG. 1a by the absence of the “X” within the cells. In the example provided by FIG. 1b, access to the cells within small subscriber areas can be accomplished on a global basis. In other words, either all the cells are available for use by users outside the cell comprising the localized service areas or all the cells are available for use only by users within the cells comprising the localized service areas. It should also be appreciated that the users are mobile stations of customers of service providers.

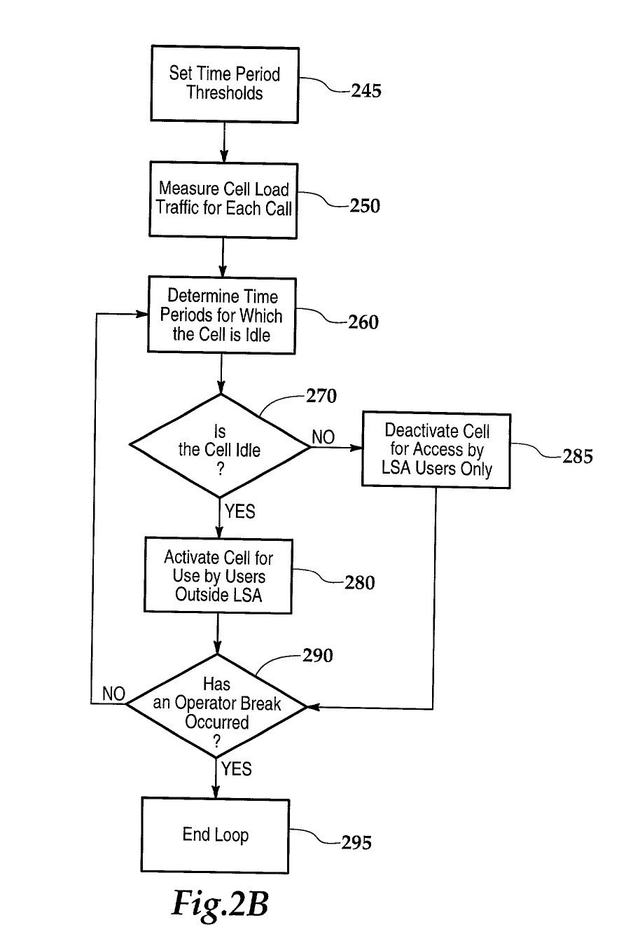

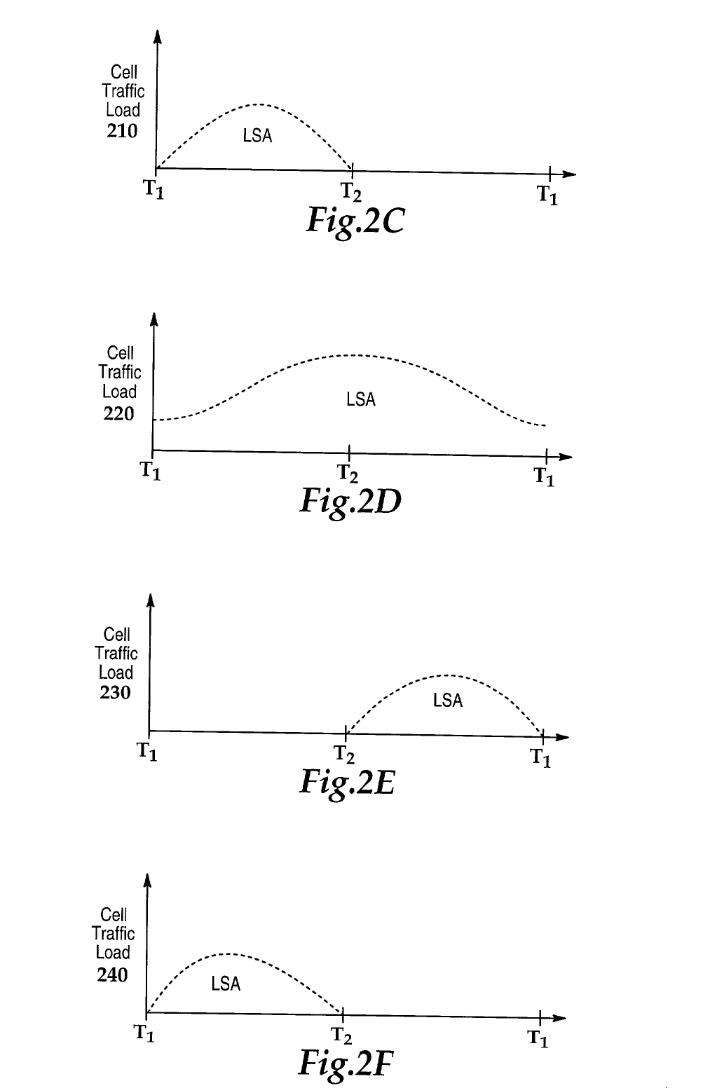

1 Referring now to FIG. 2a, an illustrative example of another embodiment of the present invention is given. FIG. 2a depicts a hierarchial cell structure similar to FIG. la. In FIG. 2a, the small subscriber area 200 includes four cells, indicated as 210, 220, 230, and 240 respectively. It should be appreciated that while the example given in FIG. 2a depicts a small subscriber area with four localized service areas, each having one cell, the localized service area can have one or more cells. It should also be noted that in FIG. 2a the cells 210, 220, 230, and 240 provide a continuous coverage area with overlapping coverage regions between the cells. It will be appreciated, however, that such a configuration does not have to exist and that the coverage area in the small subscriber area does not have to be continuous.

The method of the embodiment of the present invention depicted in FIG. 2a can be best described by referring to FIGS. 2b. The first step in the method can be to set the time periods for cell activation and deactivation, as in block 245. Next, the cell traffic loads of each cell in the localized service areas can be measured, as depicted by block 250. By measuring the cell traffic loads, a determination can then be made about which of the set time periods users within the localized service areas are using the cells and which of the set time periods the cells within the localized service areas are idle, as indicated by block 260.

After determining the time periods when the cells within the localized service areas are idle, a decision can be made whether to activate or deactivate the cells for use by users outside the localized service areas, as depicted by 270. If the cells are idle, the cells can be activated for access by users outside the localized service areas, as indicated by block 280. Likewise, if the cells are being used by the users within the localized service areas, the cells can be deactivated to restrict access to only those users within the localized service areas, as indicated by block 285. It will be appreciated that each cell within the localized service areas may have a different time period for which it can allow access by users outside the localized service area. Thus, because one cell is deactivated for access during a given time period, it does not correlate that all other cells within the localized service area will be deactivated.

Referring now to FIGS. 2c-2f, an illustrative example of the method described above in FIG. 2b is given. In FIG. 2c, a plot showing the cell traffic load for cell 210 of FIG. 2a is presented. As shown, during a time period beginning at a time T₁ and ending at a time T₂ , the cell traffic load for cell 210 for users within the localized service area is high. However, during the time period from T₂ to T₁, the cell traffic load for users within the localized service area is low. It should be appreciated that the time periods T₁ to T₂ and T₂ to T₁ represent the twenty-four hours of a day. Thus, the time period T₁ to T₂ can represent one twelve hour period of the day and the time period T₂ to T₁ can represent the other twelve hour period of the day.

FIG. 2d shows the cell traffic load for cell 220 of FIG. 2a. As FIG. 2d depicts, the cell traffic load for the time period from T₁ to T₁ for users within the localized service area is high. Referring now to FIG. 2e, a plot showing the cell traffic load for cell 230 of FIG. 2a is given. The same time periods as used in FIG. 2c are used in FIG. 2e. During the time period from T₁ to T₂, the cell traffic load due to users within the localized service area is substantially minimal. Likewise, during the time period from T₂ to T₁, the cell traffic load for users within the localized service area is high.

FIG. 2f shows the cell traffic load for the cell 240 of FIG. 2a. As FIG. 2f depicts, the cell traffic load for cell 240 is the same as the cell traffic load for cell 210, such that during the time period from T₁ to T₂ the cell traffic load for the users within the localized service area is high and during the time period T₂ to T₁ the cell traffic load for the users within the localized service area is low.

Using the plots from FIGS. 2c-2f, the cell operations for cells 210, 220, 230, and 240 can be shown. Referring back to FIG. 2a, the operation of cells 210, 220, 230, and 240 are shown during the time periods T₁ to T₂ and T₂ to T₁. As can be seen, during the time period T₁ to T₂, cells 210, 220, and 240 will be deactivated allowing access only by users within the dedicated network, indicated by the “X” in the cells. Likewise, cell 230 will be activated allowing access to users outside the localized service area during this time period, indicated by the absence of an “X” within the cell. Similarly, during the time period T₂ to T₁, cells 210 and 240 will be activated allowing access by users outside the dedicated network indicted by the absence of an “X” within the cells, and cells 220 and 230 will be deactivated allowing access by only users within the dedicated network, indicted by the “X” within the cells.

It should be appreciated that the present invention as described by FIGS. 1 and 2 may be performed by a computer program embodied on a computer readable medium. In one embodiment, the computer program may include a code segment for measuring cell traffic loads within the dedicated network. Another code segment can be included in the computer program for restricting access to the dedicated network during a first time period to users within the dedicated network. The computer program may further include a code segment for opening access to the dedicated network during a second time period to users outside the dedicated network.

The present invention may further include a computer program embodied on a computer readable medium for increasing cell use in a dedicated network. The computer program may include a code segment for measuring cell traffic loads for one or more cells within the dedicated network. The computer program may also include a code segment for determining for each of the one or more cells time periods in which the cell load traffic due to users within the dedicated network is substantially minimal. In addition, the computer program may include a code segment for allowing access to the one or more cells during the time periods when the cell load traffic due to users within the dedicated network is substantially minimal.

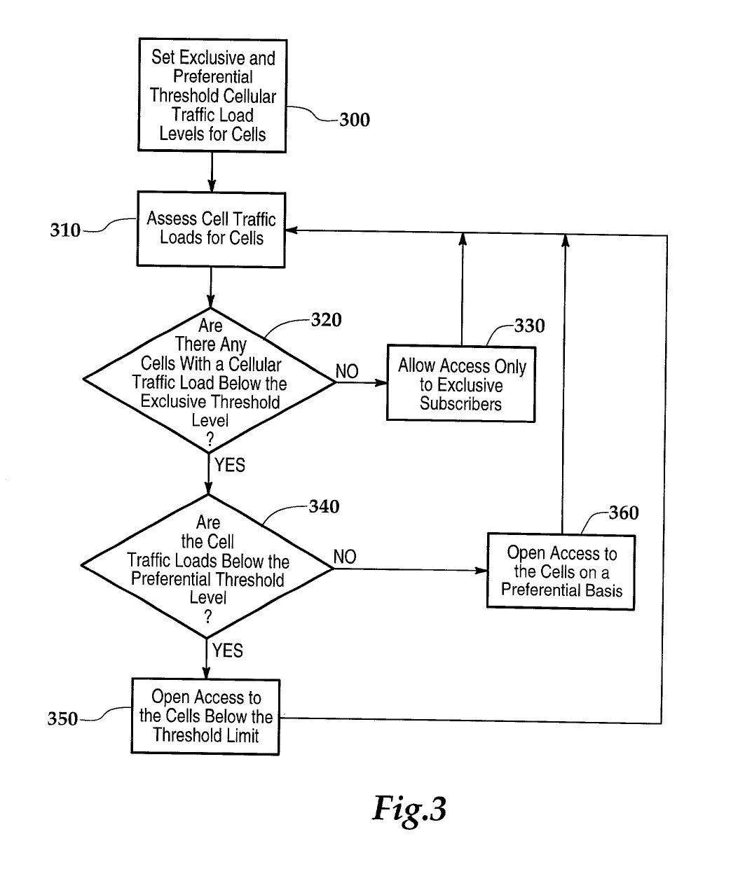

Referring to FIG. 3, a flow diagram of another method of the present invention is shown. The method includes setting Exclusive and Preferential threshold cell traffic load level for each of the one or more cells in the localized service area, as shown by block 300. After setting the Exclusive and preferential threshold cell traffic load levels, cell traffic loads for each cell within the localized service area may be assessed, as in block 310. Upon assessing the cell traffic loads for each cell, a determination can be made as to whether any of the cells have a cell traffic load below the Exclusive threshold cell traffic load level, as shown by block 320. If the cell traffic load for a cell is above the Exclusive threshold cell traffic load level, then the cell can be deactivated for access only by users within the localized service area, as in block 330. If, however, the cell traffic load for a cell is below the Exclusive threshold cell traffic load level, then a determination must be made as to whether the cell traffic load is below the preferential threshold cell traffic load level, as in block 340.

If the cell traffic load is above the preferential threshold cell traffic load level, then the cell can be activated for access by users outside the localized service area on a preferential basis, as in block 350. This means that users within the localized service area are given priority over a user outside the localized service area for accessing the cell. If, however, the cell is idle, a user from outside the localized service area can use the cells. If the cell traffic load is below the preferential threshold cell traffic load level, then the cell can be activated for access by users outside the localized service area on a non-preferential basis, as in block 360.

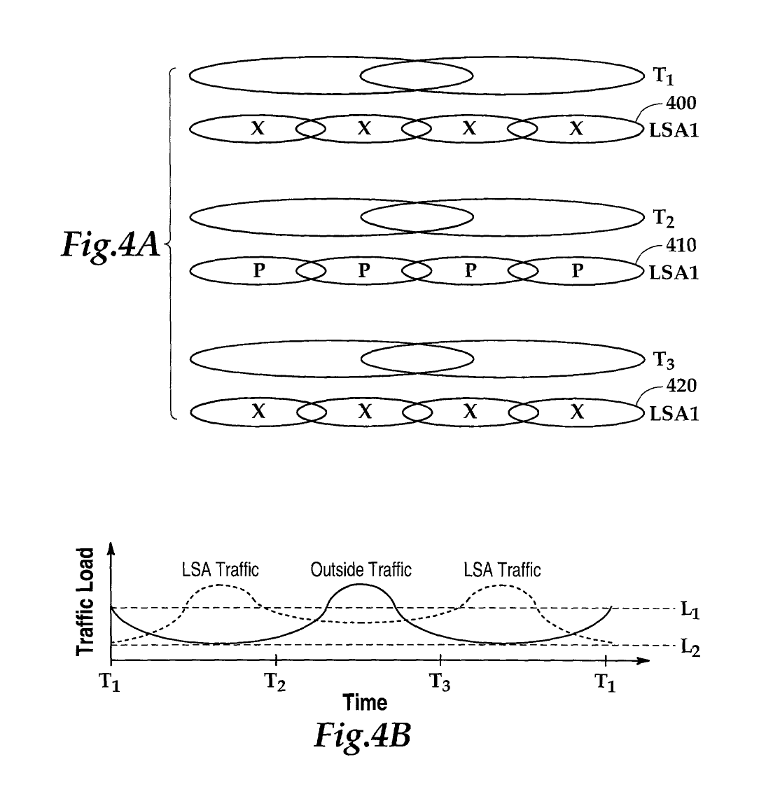

Referring now to FIGS. 4a-4b, an illustrative example of the method described in FIG. 3 is given. FIG. 4a shows a hierarchial cell structure similar to FIG. 1a.

The localized service area in FIG. 4a includes four overlapping cells. As mentioned earlier, the localized service area may have one or more cells. Additionally, the cells in the localized service area may be non-overlapping, thereby rendering the localized service area with segmented coverage. Moreover, each cell may be part of one or more localized service area.

FIG. 4b shows a plot of the cell traffic load over time for the entire group of cells comprising the localized service area. As shown, three separate time periods are examined. In each time period, the cell traffic load due to users within the localized service area are compared to the cell traffic loads due to users outside the service area. FIG. 4b depicts the Exclusive threshold cell traffic load level as L1 and the preferential cell traffic load level as L2.

In the first time period from T₁ to T₂, the cell traffic load due to users in the localized service is higher than the LAS threshold cell traffic load level L1. During this time period as shown by 400 in FIG. 4a, the cells in the localized service area are deactivated restricting access to use by only users within the localized service area, as indicted by the “X” within the cells. In the second time period of FIG. 4b, from T₂ to T₃, the cell traffic load due to users within the localized service area falls between the LSA threshold cell traffic load level L1 and the preferential threshold cell traffic load level L2. During this time period, as shown by 410 in FIG. 4a, the cells of the localized service area are activated such as to permit access to the cells by users outside the localized service area on a preferential basis, as indicated by the “P” within the cells. That is, if a need arises that the users within the localized service area require access, then those users will gain access to the cells over users outside the localized service area.

In a third time period from T₃ to T₁ in FIG. 4a, the cell traffic load from users within the localized service area is once again above the LSA threshold cell traffic load level L1 and thus the cells within the localized service are deactivated for use only by users within the localized service area, as shown by 420 in FIG. 4 and indicated by the “X” within the cells.

It should be appreciated that while the example given by FIG. 4 shows the activation or deactivation of the group of cells comprising the localized service area, the same operation can be accomplished on an individual cell by cell basis. In other words, each cell can have a threshold cell traffic load established and then the cell load traffic for each cell can be monitored to determine if the cell should be activated or deactivated for use by users outside the localized service area.

In another embodiment, the computer program may include a code segment for determining a threshold level of cell traffic load for the one or more cells within the dedicated network. The computer program may also include a code segment for assessing the one or more cells to determine if any cells have cell traffic loads below the threshold level. The computer program may further include a code segment for allowing access by users outside the dedicated network to the cells with traffic loads below the threshold level.

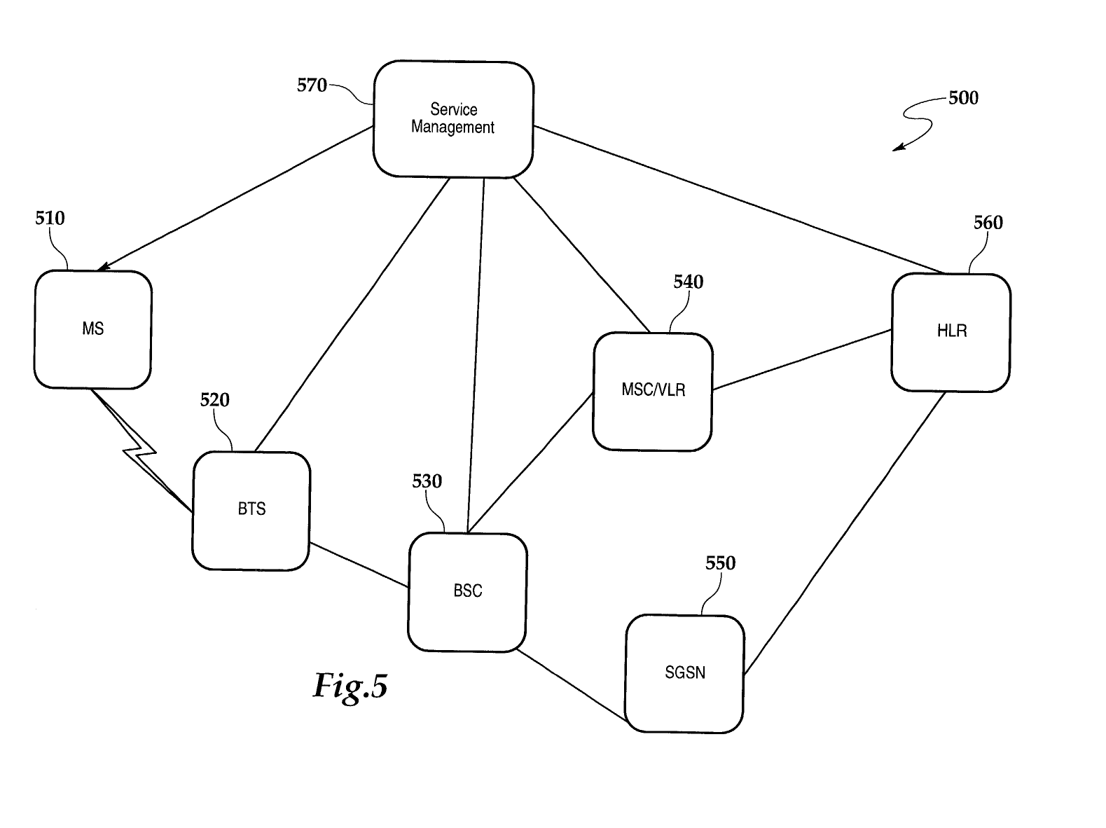

Referring now to FIGS. 5, a telecommunications network is generally depicted as 500. The telecommunications network is a standard telecommunications having a mobile station (MS) 510, a Base Transceiver Station system (BTS) 520, a base station controller (BSC) 530, a mobile switching center/visitor location register (MSC/VCR) 540, a Serving GPRS Support Node (SGSN) 550, a home location register (HLR) 560 and a Service management node 570. In implementing the present invention, some functionality of the different components of the telecommunications network need to be adjusted or better utilized.

For example, in one configuration, the LSA operation and maintenance entities in the base station controller 530 and/or Service management node 570 may need to be updated to include threshold testing, decision making, interworking with cell configuration handling parts, and if needed, initiation forced handover. Similarly, to implement the present invention, one may need to configure the Base station System 520 and/or Service management node 570 to obtain cell traffic statistics. These measurements can be both from cell traffic recording and mobile traffic recording. This functionality may also be performed at the base station controller 530. LSA specific measurements, such as the number of LSA only connection attempts per LSA, maybe obtained at the base station controller 530.

While specific alternatives to steps of the invention have been described herein, additional alternatives not specifically disclosed but known in the art are intended to fall within the scope of the invention. Thus, it is understood that other applications of the present invention will be apparent to those skilled in the art upon the reading of the described embodiment and a consideration of the appended claims and drawings.

What is claimed is:

1. A method of increasing cell use in a dedicated network comprising the steps of:
measuring cell traffic loads within the dedicated network;
restricting access to the dedicated network during a first time period to users within the dedicated network; and
allowing access to the dedicated network during a second time period to users outside the dedicated network.

2. The method of claim 1 wherein the dedicated network is a localized service area.

3. The method of claim 2 wherein the localized service area includes one or more cells.

4. The method of claim 1 wherein the first time period is a peak operation time period for the users within the dedicated network.

5. The method of claim 1 wherein the second time period is a non-peak operation time period for the users within the dedicated network.

6. The method of claim 1 wherein the users are mobile stations.

7. A computer program embodied on a computer readable medium for increasing cell use in a dedicated network comprising:
a code segment for measuring cell traffic loads within the dedicated network;
a code segment for restricting access to the dedicated network during a first time period to users within the dedicated network; and
a code segment for opening access to the dedicated network during a second time period to users outside the dedicated network.

8. The computer program of claim 7 wherein the dedicated network is a localized service area.

9. The computer program of claim 8 wherein the localized service area includes one or more cells.

10. The computer program of claim 7 wherein the first time period is a peak operation time period for users within the dedicated network.

11. The computer program of claim 7 wherein the second time period is a non-peak operation time period for users within the dedicated network.

12. The computer program of claim 7 wherein the users are mobile stations.

13. A method of increasing cell use in a dedicated network comprising the steps of:
determining a threshold level of cell traffic load for the one or more cells within the dedicated network;
assessing the one or more cells to determine if any cells have cell traffic loads below the threshold level; and
allowing access by users outside the dedicated network to the cells with cell traffic loads below the threshold level.

14. The method of claim 13 wherein the dedicated network is a localized service area.

15. The method of claim 13 wherein the users are mobile stations.

16. A computer program embodied on a computer-readable medium for increasing cell use in a dedicated network comprising:
a code segment for determining a threshold level of cell traffic load for the one or more cells within the dedicated network;
a code segment for assessing the one or more cells to determine if any cells have cell traffic loads below the threshold level; and
a code segment for allowing access by users outside the dedicated network to the cells with traffic loads below the threshold level.

17. The computer program of claim 16 wherein the dedicated network is a localized service area.

18. The computer program of claim 16 wherein the users are mobile stations.

19. A method of increasing cell use within a dedicated network comprising the steps of:
measuring cell traffic loads for one or more cells within the dedicated network;
determining for each of the one or more cells time periods in which the cell load traffic due to users within the dedicated network is substantially minimal; and
allowing access by users outside the dedicated network to the one or more cells during the time periods when the cell load traffic due to users within the dedicated network is substantially minimal.

20. The method of claim 19 wherein the dedicated network is a localized service area.

21. The method of claim 19 wherein the users are mobile stations.

22. A computer program embodied on a computer-readable medium for increasing cell use in a dedicated network comprising:
a code segment for measuring cell traffic loads for one or more cells within the dedicated network;
a code segment for determining for each of the one or more cells time periods in which the cell load traffic due to users within the dedicated network is substantially minimal; and
a code segment for allowing access by users outside the dedicated network to the one or more cells during the time periods when the cell load traffic due to users within the dedicated network is substantially minimal.

23. The computer program of claim 22 wherein the dedicated network is a localized service area.

24. The computer program of claim 22 wherein the users are mobile stations.
